(19) United States
(12) Patent Application Publication
(10) Pub. No.: US 2018/0357706 A1
(43) Pub. Date: Dec. 13, 2018

(54) Methods, Apparatuses, and Systems for Online Sales

(71) Applicant: Truth in Design, Inc., San Francisco, CA (US)

(72) Inventor: Hamilton Souther, San Francisco, CA (US)

(73) Assignee: Truth in Design, Inc., San Francisco, CA (US)

(21) Appl. No.: 15/616,363

(22) Filed: Jun. 7, 2017

(51) Int. Cl. G06Q 30/06; G06F 17/30; G06Q 20/40; G06Q 30/02; H04W 4/14; H04L 12/58; G06F 3/0483; G06F 3/0488

(52) U.S. Cl. CPC G06Q 30/0633; G06F 17/30377; G06Q 20/4012; G06Q 30/0239; G06F 3/04883; G06Q 30/0627; H04W 4/14; H04L 51/08; G06F 3/0483; G06Q 30/0643

(57) ABSTRACT

An electronic marketplace is disclosed. Merchants post products to the marketplace. The marketplace serves product pages for posted products to consumers. Consumers may purchase products without the use of a shopping cart. Consumers may also discovery related products without regard to the identity of the merchant or source of the products.

### BACKGROUND OF THE INVENTION

Online merchants have adopted a shopping experience modeled after the traditional “brick and mortar” shopping cart experience. That is, the consumer places selected items for purchase into his or her shopping cart and proceeds to checkout area where the sales transaction takes place. This model aligns with the merchant's goal of encouraging consumers to purchase additional products by having more opportunities to present additional products to the consumer, but the model also lengthens the purchasing process for the consumer. For example, a consumer may wish to purchase product A from an online merchant. The consumer must browse or search the merchant's web site to locate product A. Upon locating the product, the consumer adds it to his or her shopping cart. Then the merchant may present a new page to show the consumer other products, which may be related to the product in the shopping cart or frequently purchased with it. The consumer must then navigate to the shopping cart page and to the checkout page. In some cases, the presentation of additional products may aid the consumer, but in other cases, the additional steps required to complete the purchase (e.g., viewing additional products, viewing the shopping cart, proceeding to checkout) impede the transaction. In addition, the small screen size of portable devices (e.g., less than 7″ diagonal screen) means that the amount of information displayed per page and the number of pages that the consumer must navigate in existing online shopping processes complicates the purchasing process.

In addition, in the traditional online shopping experience, a consumer is locked into viewing products sold by a single merchant, at least until the consumer decides to complete a transaction or to visit a different merchant's website. For example, a consumer seeking to purchase product A from merchant A's site will not have the advantage of being able to easily compare product A on merchant B's site without having to separately navigate to the product A page on merchant B's site. While some search engines allowing for a consumer to search for products across multiple merchants, once the consumer identifies the product they wish to purchase, the consumer is still forced into the merchants traditional shopping cart model purchasing experience.

### BRIEF SUMMARY OF THE INVENTION

Embodiments of the invention are directed to a marketplace service that directly links the consumer to the product. Other embodiments include the ability to use requests to URI locations to locate products. Other embodiments include the ability to easily navigate between similar or products sold from the same merchant and/or similar or identical products sold from different merchants.

A first aspect of the disclosure provides a computer-implemented method of providing a product marketplace, comprising executing on one or more processors the steps of receiving product information from a first device, the product information comprising an image and a description; in response to receiving the product information, creating a product record in a first database, the product record having a unique product identification number, the product record storing the image and the product description or having a reference to the image and a reference to the product description; generating a reference to the product record; receiving the reference to the product record from a second device as part of a product page request; retrieving at least a portion of the product record from the first database; generating the product page, the product page comprising the portion of the product record retrieved from the first database; and sending the product page to the second device.

A second aspect of the disclosure provides a computer-implemented method of purchasing a product, comprising executing on one or more processors the steps of sending a request based on a URI; receiving a product page related to a first product available from a first merchant in response to the request; displaying the product page; receiving an input from a user; determining whether the input was of a first type; and if the input was of a first type, sending a purchase request based in part on information contained in the product page and without placing the first product in a shopping cart. Other aspects of the present invention are described in herein and reflected in the claims. These aspects provide several unique advantages over the traditional online shopping experience.

### BRIEF DESCRIPTION OF THE SEVERAL VIEWS OF THE DRAWINGS

The figures and the following description describe certain embodiments by way of illustration only.

FIG. 1 depicts a traditional product purchasing arrangement between consumers and merchants.

FIG. 2A depicts an exemplary embodiment of a multi-merchant marketplace through which consumers directly browse products without being tied to a merchant.

FIG. 2B depicts an exemplary embodiment of the marketplace shown in FIG. 2A.

FIG. 3 depicts an exemplary embodiment of a consumer dashboard.

FIG. 4 depicts an exemplary embodiment of a merchant dashboard.

FIG. 5 depicts an exemplary embodiment of the interface through which a merchant adds products to the marketplace.

FIG. 6 depicts an exemplary embodiment of a process through which a merchant adds products to the marketplace.

FIG. 7 depicts an exemplary embodiment of a process through which the marketplace evaluates relationships between products in the marketplace.

FIG. 8 depicts an exemplary embodiment of an interface through which a merchant may obtain links to a product.

FIG. 9A depicts an exemplary process through which a consumer may purchase a product.

FIG. 9B depicts another exemplary process through which a consumer may purchase a product.

FIG. 10 depicts an exemplary user interface through which a consumer may purchase a product.

FIG. 11 depicts an exemplary user interface through which a consumer may purchase a product.

FIG. 12 depicts another exemplary user interface through which a consumer may purchase a product.

FIG. 13 depicts an exemplary process through which a consumer may receive product pages for similar and/or identical products.

FIG. 14 depicts an exemplary device that a consumer may use to purchase a product.

### DETAILED DESCRIPTION OF THE INVENTION

One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

As used herein, the term “merchant” may refer to retailers, manufacturers, distributors, wholesalers, or any other entity selling goods to consumers. The term “consumer” may refer to individuals or businesses purchasing goods from a merchant.

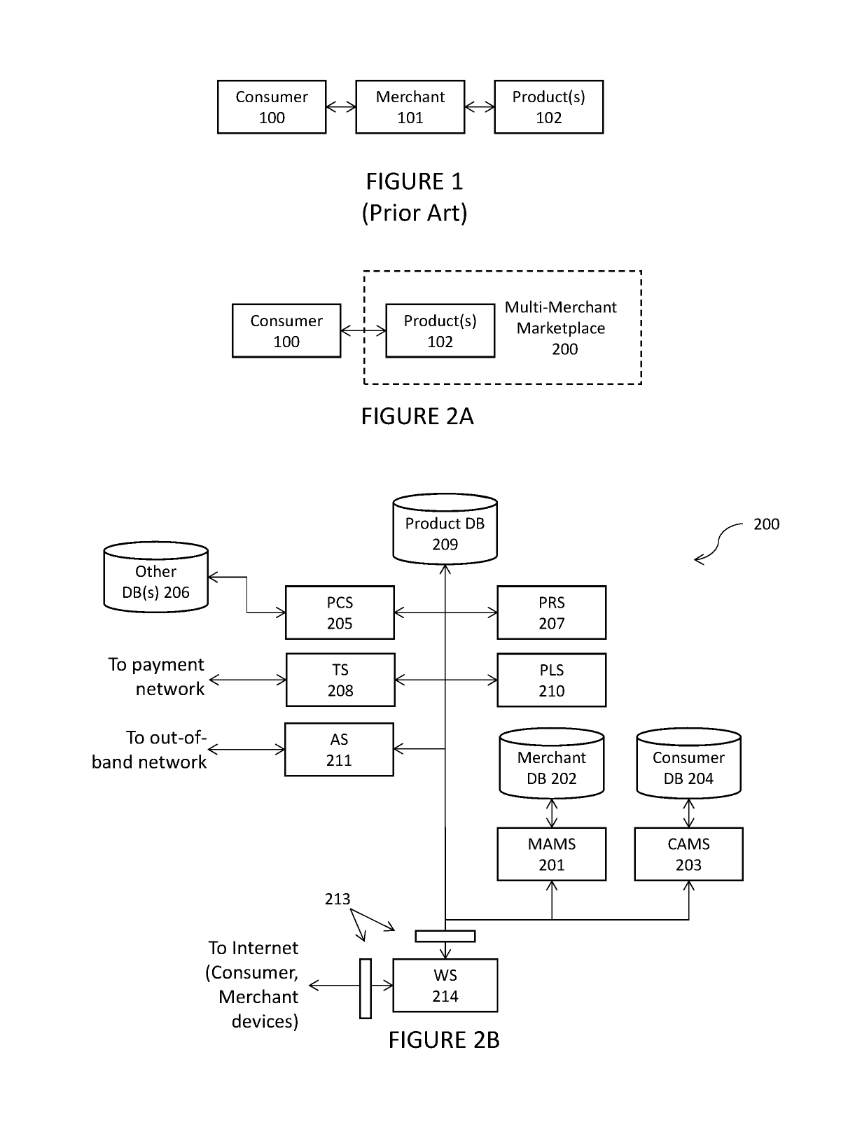

FIG. 1 depicts a typical relationship between consumer 100, merchant 101, and products 102 in online shopping. Consumer 100 browses the website of merchant 101 for products 102. Consumer 100 selects certain items for purchase which are added to a shopping cart. Consumer 100 is unable to compare similar or related products that are higher quality or lower price, as examples, and available from another merchant. This limits the consumer's ability to purchase specific products without the traditional shopping cart model and to compare similar or identical products among merchants.

### Marketplace Services

FIG. 2A depicts an online shopping experience according to one aspect of the inventions disclosed herein. In contrast to FIG. 1 where consumers interface directly with merchants, separate merchants are grouped together in a multi-merchant marketplace 200. Each of the products 102 of a particular merchant are aggregated for the consumer 100 such that the consumer 100 may locate or browse and purchase products 102 without regard to the merchant's identity. Additionally, products may be presented to consumer via a selectable URI on a website, in an email, via text or through various social media services.

FIG. 2B depicts an exemplary embodiment of the marketplace 200. Marketplace 200 operates on the Internet. Marketplace 200 includes Merchant Account Management Service (“MAMS”) 201, Consumer Account Management Service (“CAMS”) 203, Product Creation Service (“PCS”) 205, Product Relation Service (“PRS”) 207, Transaction Service 208 (“TS”), Product Location Service 210 (“PLS”), Authentication Service 211 (“AS”), Third-Party Scan Service (“3PS”) 212, and Web Service (“WS”) 214, each of which is described below. These services may run as processes on one or more processors on one or more computers. For security, one or more firewalls 213 may be included to isolate WS 214 from the Internet and the remainder of the marketplace 200 from the WS 214. Communications to and from the marketplace 200 may be secured via TLS/SSL. Additional security measures may be used for sensitive information (e.g., payment information, to authenticate a consumer, etc.).

Additionally, marketplace 200 may include one or more databases. As shown, marketplace 200 includes a merchant database 202, a consumer database 204, a product database 209, and one or more other databases 206. The partitioning of the information contained in these databases may vary. For example, the information described as being stored in databases 202 and 204 may be combined into a single database. Databases may be stored on one or more non-volatile memories. Communication between databases and services may be indirect or direct in that a database service (not shown) may handle requests to read or write to a database.

### Web Service

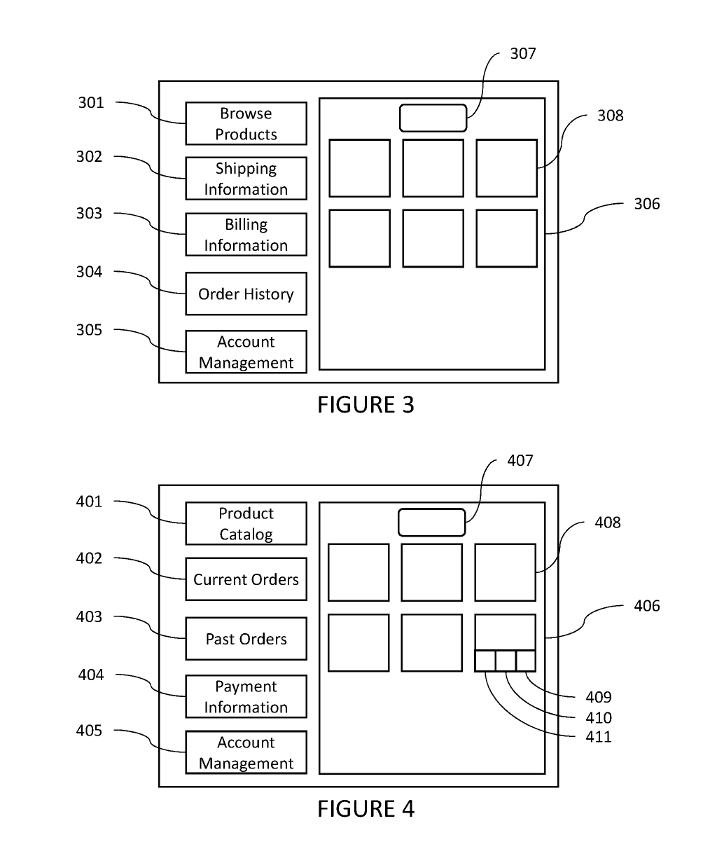

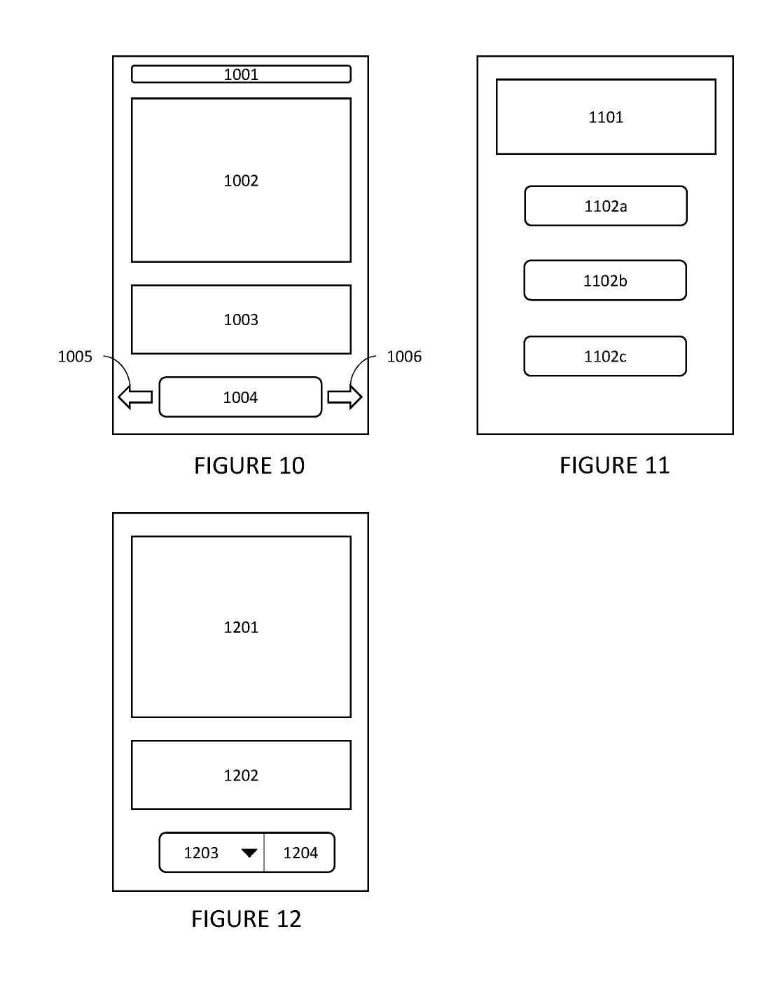

Web Service (“WS”) 214 receives and processes queries from merchants and consumers via the Internet. WS 214 responds to all page queries, including serving product pages, merchant and consumer dashboards, and other pages as described below. Product pages may include one or more product images, a product description, and a button or link to initiate a product purchase. FIGS. 10 and 12 depict exemplary product pages. The consumer dashboard allows a consumer to manage its account, including purchase preferences (e.g., authentication settings), shipping addresses, and payment information. FIG. 3 depicts an exemplary consumer dashboard. The merchant dashboard allows a merchant to manage its account, including adding or removing products, generating links to product pages, limiting products pages to be displayed in certain geographic areas (e.g., due to shipping constraints), and configuring bank account information for product purchases. FIG. 4 depicts an exemplary merchant dashboard. The dashboards are preferably implemented as web pages that may be accessed via the Internet by consumers and merchants via a client (e.g., a web browser). While the description herein contemplated web pages that are accessed through a web browser, standalone programs may be installed on consumer and merchant devices to provide the functionality described herein.

### Consumer Account Management Service

The Consumer Account Management Service (“CAMS”) 203 manages consumer accounts. CAMS 203 may store consumer account information in consumer database 204. CAMS 203 is responsible for allowing the creation and maintenance of consumer accounts with the marketplace 101.

CAMS 203 handles consumer account creation. In response to a create consumer account request from WS 214 that includes consumer information (e.g., name, address, billing information, contact information, etc.), CAMS 203 creates a new entry in consumer database 204 with the consumer's information and assigns the consumer a unique consumer identification number. The consumer identification number is used to uniquely identify the consumer and, optionally, its purchases via the marketplace.

Consumers manage their accounts through a consumer dashboard. The consumer accesses his or her dashboard via an electronic device (e.g., a laptop or smartphone). Upon directing the device to the consumer dashboard, the WS 214 prompts the consumer for access credentials. Upon providing access credentials to WS 214, WS 214 responds by providing the consumer with a dashboard through which the consumer may manage his or her account, including shipping, payment, and contact information.

An exemplary consumer dashboard is depicted in FIG. 3. The consumer dashboard may include a browse products link 301. In response to the user selecting the browse products link 301, the WS 214 sends product information 308 for display by the consumer's device. Product information 308 may include an image of the product and a description of the product. Product information 308 may be displayed for several products in a tabular row and column format in display area 306. Alternatively, display area 306 may display product information for a single product at a time. Display area 306 may optionally display a search field 307 for the consumer to search for products.

The consumer dashboard may include a shipping information link 302. In response to the user selecting the shipping information link 302, the WS 214 may provide a shipping information page to the consumer's device for display in display area 306. The shipping information page may include previously stored addresses that are retrieved from the consumer database 204 by the CAMS 203. The consumer may add, edit, or remove addresses via the shipping information page. Changes to the consumer's addresses are relayed through the WS 214 to the CAMS 203 for storage in the consumer database 204.

The consumer dashboard may include a billing information link 303. In response to the user selecting the billing information link 303, the WS 214 may provide a billing information page to the consumer's device for display in display area 306. The billing information page may include previously stored payment information that may be used to pay for product purchases that are retrieved from the consumer database 204 by the CAMS 203. The consumer may add, edit, or remove payment information via the billing information page. Changes to the consumers' billing information are relayed through the WS 214 to the CAMS 203 for storage in the consumer database 204.

The consumer dashboard may include an order history link 304. In response to the user selecting the order history link 304, the WS 214 may provide an order history page that includes some or all of the consumer's prior marketplace purchases. The WS 214 may provide this information by querying the CAMS 203 for purchase history information associated with the consumer stored in the consumer database 204. Consumer database 204 may store a unique record for every marketplace transaction. Each record may contain a unique transaction number, a unique consumer identification number, a unique merchant identification number, a unique product identification number, and additional information (e.g., date, price, payment information, shipping information etc.). Given the ease of purchasing products, recent orders may preferably include an option to cancel the order for a set amount of time after placing the order. Thus, a consumer that inadvertently ordered a product can cancel the order before it is processed.

The consumer dashboard may include an account management link 305. In response to the user selecting the account management link 305, the WS 214 may provide an account management page allows the consumer to change its account settings. The WS 214 may provide this information by querying the CAMS 203 for account settings associated with the consumer stored in the consumer database 204. Exemplary account settings include merchant ratings filters, account credentials management, and purchase authentication settings. In some embodiments, the consumer may configure his or her account to only allow access from certain devices. The consumer registers those devices with the marketplace. Only registered devices may access the consumer's account and complete a purchase. Device registration information is stored by the CAMS 203 in the consumer database 204. Changes to registered devices may require two forms of authentication (e.g., challenge response, biometric, etc.). Registration may entail storing a public key uniquely associated with the device in consumer database 204. In some embodiments, the consumer may register a response to be provided by the consumer when asked by the marketplace. For example, the user may set a personal identification number (“PIN”), answer to a security question, or select an image to be used as the response when the marketplace requests the consumer confirm his or her identity based on knowledge of the response. In some embodiments, the consumer may specify a merchant ratings filter. Ratings may be aggregated for each merchant over time. The consumer may set a minimum rating threshold which will filter out products sold from merchants below that threshold.

Note that display area 306 may be displayed on the same screen as the various consumer dashboard links 301-305 or may include a navigation link that the consumer may select to cause the display of consumer dashboard links 301-305.

### Merchant Account Management Service

The Merchant Account Management Service (“MAMS”) 201 manages merchant accounts. MAMS 201 may store consumer account information in merchant database 202. MAMS 201 is responsible for allowing the creation and maintenance of merchant accounts with the marketplace 101.

MAMS 201 handles merchant account creation. In response to a create merchant account request from WS 214 that includes merchant information (e.g., name, address, billing information, contact information, etc.), MAMS 201 creates a new entry in merchant database 202 with the merchant's information and assigns the merchant a unique merchant identification number. The merchant identification number is used to uniquely identify the merchant and, optionally, the merchant's products in the marketplace.

Merchants manage their accounts through a merchant dashboard. Upon providing access credentials to WS 214, WS 214 responds by providing the merchant with a dashboard through which the merchant may manage its product offerings, including adding and removing products.

An exemplary merchant dashboard is depicted in FIG. 4. The merchant dashboard may include a product catalog link 401. In response to the merchant selecting the product catalog link 401, the WS 214 sends product information 408 for display by the merchant's device. Product information 408 may be displayed for several products in a tabular row and column format in display area 406. Alternatively, display area 406 may display product information for a single product at a time. In addition to displaying product information 408 for a product, display area 406 may include a link 407 to add new products. For each displayed product, display area 406 may also include a link 409 to delete a product, a link 410 to view/update/create links that may be used to externally access the product page by a consumer, and a link 411 to edit product information (e.g., to update the price).

The merchant dashboard may include a current orders link 402 and a past orders link 403. In response to the merchant selecting the current orders link 402 or the past orders link 403, the WS 214 sends a page containing information related to current orders or past orders, respectively. The merchant dashboard may include a payment information link 404 for the merchant to provide account information through which the merchant may receive payments for processed orders (e.g., bank routing and account number information for electronic funds transfer).

The merchant dashboard may include an account management link 405. In response to the merchant selecting the account management link 305, the WS 214 may provide an account management page that allows the merchant to change its account settings. The WS 214 may provide this information by querying the MAMS 201 for account settings associated with the merchant stored in the merchant database 202. Exemplary account settings include account credentials management and notification settings. In some embodiments, the merchant may configure its account to only allow access from certain devices. The merchant registers those devices with the marketplace. Only registered devices may access the merchant's account. Device registration information is stored by the MAMS 201 in the merchant database 202. Changes to registered devices may require authentication (e.g., challenge response, biometric, etc.). Registration may entail storing a public key uniquely associated with the device in merchant database 202. Other account settings include notification settings to allow the merchant to specify how the merchant is notified of new orders.

Note that display area 406 may be displayed on the same screen as the various merchant dashboard links 401-405 or may include a navigation link that the merchant may select to cause the display of merchant dashboard links 401-405.

### Product Creation Service

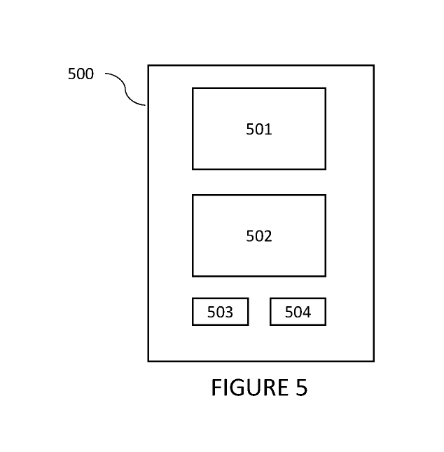

A merchant may add products via its merchant dashboard. Products are added via an add product page. FIG. 5 depicts an exemplary add product page 500. The add product page 500 may include an image field 501 (for the merchant to add one or more images of the product), a description field 502 (for the merchant to add a written product description), an inventory field 503 (for the merchant to specify the number of the products that may be sold), and a price field 504 (for the merchant to specify the purchase price). Other fields may be included, such as a field to specify geographical restrictions on shipments, a field to provide a standardized product identification number (e.g., EAN, UPC), a field to specify one or more products that the merchant wishes to relate to the new product, or fields to identify warranty, return, product category and subcategories (e.g., “textiles” and “t-shirts” or “tools” and “socket wrenches”), and/or other appropriate product information. The add product page may optionally include a field to create a link which consumers may use to access the product's page once it has been added.

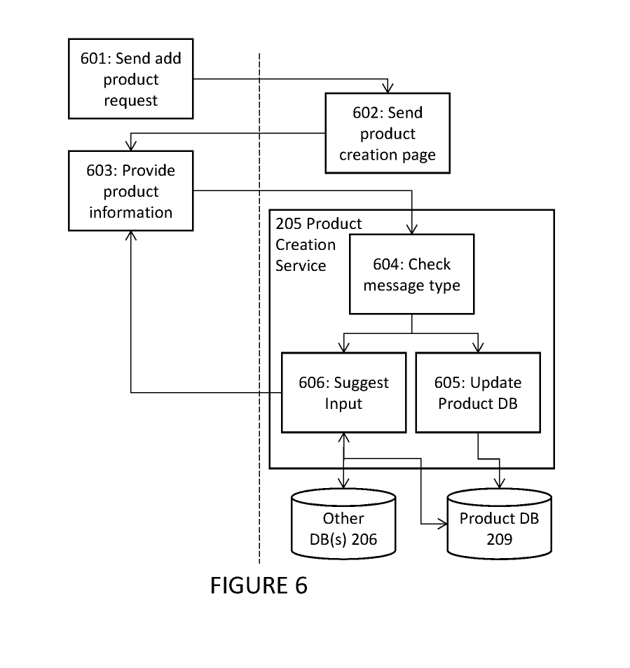

An exemplary product creation process is shown in FIG. 6. At step 601, a merchant sends an add product request (e.g., via link 407) to WS 214. At step 602, WS 214 responds to the merchant's request by sending an add product page to the merchant's client. As depicted in FIG. 5, the add product page may include one or more fields to be filled in by the merchant. At step 603, the merchant fills out the available fields and submits the request to add a new product to the WS 214. In one embodiment, the WS 214 passes the filled-out information along with an indication to add the product to the Product Creation Service (“PCS”) 205. The PCS 205 adds the product to the product database 209. In the embodiment shown, as the merchant fills out the available fields, the add product page may include instructions to send a message to the WS 214 requesting predictive inputs for the current or remaining fields that includes at least a portion of the information that the merchant has already filled out. In this embodiment, the WS 214 may pass the message to the PCS 205, which checks the message type at step 604 (request to add a new product or for predictive inputs). Alternatively, the WS 214 may check the message and send an appropriate message to PCS 205. If the message is a request to add a new product, the PCS 205 proceeds to step 605 and updates the product database 209. If the message is a request for predictive inputs, the PCS may consult the product database 209 and/or one or more other databases 206 for a suggested input based on the information the merchant has already filled out and send the suggested input back to the merchant's client via WS 214. The other databases 206 may be part of the marketplace or may be provided by a third party and accessed via an API. For example, if the merchant provides a UPC number, the PCS 205 may consult a database of UPC numbers that include product descriptions and suggest the corresponding product description to the merchant. The suggested inputs are relayed through the WS 214 to the merchant's client and may appear on the add product page in a drop-down menu or in stylized text (e.g., italics) for the merchant to select. This process—requesting and suggesting predictive inputs—may occur many times as the merchant advances through filling out the fields on the add product page, with the suggested inputs being refined as the merchant specifies additional information. Once the message is an add product request, the process proceeds to step 605 and the PCS 205 updates the product database 209.

When the PCS 205 updates the product database 209, each product is assigned a unique product identification number (which may be different than or the same as a standardized product identification number). Additionally, the product database may include the merchant's identification number to associate the product with the merchant. The PCS 205 (or the WS 214, if it detects the add product request) may instruct the MAMS 201 to update the merchant database 202 to associate the merchant's unique identification number with the newly created unique product identification number.

### Product Relation Service

As mentioned above, when a merchant adds a new product, the merchant may identify one or more other products to which a new product relates. The merchant may identify the other product(s) via unique product identification numbers or links to the products (described below). In addition to allowing the merchant to relate products during the product creation process, the marketplace may automatically relate products. This is performed by the product relation service (“PRS”) 207. PRS 207 may run periodically (e.g., every hour, every day) or in real-time (e.g., as products are added) to relate products.

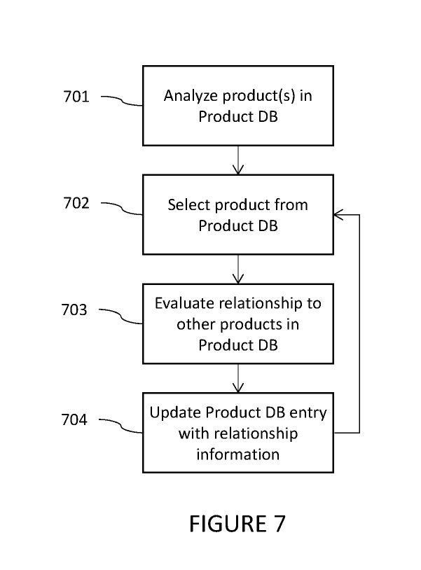

FIG. 7 shows an exemplary series of steps performed by the PRS 207 to relate products. Initially at step 701 the PRS 207 analyzes product(s) in the product database 209 that have not been previously been analyzed. This may be many products (when the PRS 207 is run periodically) or a single product (when the PRS 207 is run in real-time). The PRS 207 analyzes the information regarding the product to develop a logical representation of the product. For example, the PRS 207 may analyze the product description to determine the frequency of frequently or infrequently appearing terms or term sets (e.g., “waterproof,” “tablecloth,” “running shoe,” “burgundy”). The PRS 207 updates the product database 209 by storing the logical representation of the product and associating it with the product's unique product identification number. If the merchant did not specify a product category or subcategory when the merchant added the product, the PRS 207 may categorize the product.

At step 702, the PRS 207 selects a product from the product database. At step 703, the PRS 207 then compares the logical representation of the selected product with each logical representation of a plurality of other products. The plurality of other products may be all of the other products in the product database 204 or a subset of the other products in the product database 204. For example, a subset may be comprised of products in the same product category or subcategory. As part of the comparison, the PRS 207 determines a similarity score between the selected product and each of the products used in the comparison. The scores may then be sorted from most similar to least similar. At step 704, the PRS 207 stores the identities of the sorted products in the product database 204 in order and associates those products with the selected product (e.g., via a list of the unique product identification numbers). Scores below a certain threshold may be used to eliminate certain products or limit the number of “similar” products (e.g., eliminate all scores below one standard deviation above the mean score or eliminate all but the 10 most similar products). PRS 207 may also store the identities of the sorted products that are sold by the same merchant (having matching merchant identification numbers) in the product database 204 and associated with the selected product. PRS 207 may then repeat steps 702 through 704 for the next selected product.

Other factors may be used to adjust the similarity score between two products. For example, the marketplace may save the initial product page served to a consumer. When the consumer browses through related products and ultimately purchases a related product, the marketplace may increase the similarity score between the initial product and the purchased product so that the purchased product is closer to the initial product in the ordered list of related products.

### Product Linking Service

When a merchant wants to advertise or otherwise make available a certain product, the merchant may select link 410 to view/update/create links that may be used to externally access the product page by a consumer. In response to selecting link 410, WS 214 may provide the merchant with a link editing page to view/update/create links to a product's product page.

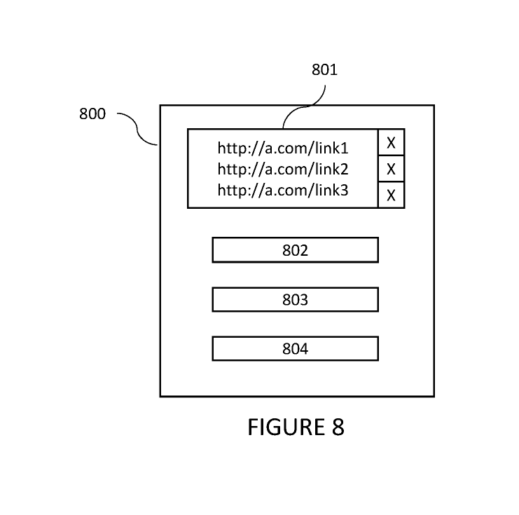

An exemplary link editing page is shown in FIG. 8. Page 800 may include a display area 801 to display existing links including an option to delete existing links. Page 800 may also include a field 802 for the merchant to type in one or more keywords that the merchant would like to incorporate into the product link (e.g., “sale,” “handcrafted chair”). In response to providing the keywords, the merchant's client may pass the keyword information to the WS 214. The WS 214 may then query the Product Linking Service “PLS” 210 for a suggested and unique link. Upon receiving a suggested and unique link, the WS 214 may relay the suggested link to the merchant's client, which displays the suggested link in field 803 (e.g., http://a.com/handcrafted_chair_sale). The merchant may opt to edit the keywords in field 802 and/or the suggested link in field 803, which causes the merchant's client to send the updated information to the WS 214, the WS 214 to request a suggested and unique link from the PLS 210, and the WS 214 to relay the suggested and unique link from the PLS 210 back to the merchant's client for display in field 803. The merchant may use keywords to convey a variety of information to the consumer in the link (e.g., the product, promotions, discounts, the merchant's identity). This process may repeat until the merchant is satisfied with the link. At that stage, the merchant may select link 804 to add the newly created link to the product. The PLS 210 may store each of the generated links to a product in the product database 209 and/or in another database that the WS 214 accesses when handling page requests. If more than one link is created, the merchant may identify a primary link that may be sent to the consumer's device and displayed to the user.

### Transaction Service

A Transaction Service (“TS”) 208 may provide credit and debit processing for the merchants. TS 208 may receive transaction details from the marketplace and transmit the transaction to the acquirer or payment network for authorization. TS 208 may also carry out funds transfer between the consumer's bank and the merchant's bank.

### Authentication Service

The Authentication Service (“AS”) 211 is used to authenticate the user making the purchase. In one embodiment, the user must login at some point in time to the marketplace. The user's login credentials may be securely stored within the user's device to be accessed whenever the user attempts to establish a secure session with the marketplace. Note that TLS or another encryption technique may be used to secure the communication channel between the consumer's device and marketplace. In addition to securing the communication channel, an authentication of the consumer's device may occur via a message from the user's device that is encrypted with a private key associated with the user's device, the counterpart of which was stored by the marketplace if the user registered a device with the marketplace, described above. Alternatively, the consumer's device may be authenticated during negotiation of a shared session key during the TLS handshake.

To prevent fraudulent transactions, various forms of authentication may be required beyond the user logging on with a username and password. One embodiment of the authentication service may involve the use of an out-of-band network to authenticate the user making a purchase. For example, if the WS 214 receives a purchase request, the WS 214 may provide a page that prompts a user for a PIN while the AS 211 may send a PIN via SMS to the mobile phone of the consumer or via email to consumer's email address, subject to whatever information is registered with the consumer's account (e.g., phone number or email address). The AS 211 may send the PIN simultaneously over one or more communication channels.

In another embodiment, authentication may be carried out on the consumer's device. If the device offers an API for confirming the device user's identity via a biometric characteristic (e.g., a fingerprint), the authentication step may involve instructions causing the browser or other application running on the consumer's device to prompt the user to confirm his or her identity via the biometric input.

In another embodiment, consumer authentication may occur by querying the consumer for an expected response that was previously selected or input by the consumer into the marketplace. That response may be a stored PIN, image, or answer to a secret question that the consumer saved in his or her account settings/during account creation.

In another embodiment, consumer authentication may be simplified by relying only on a user's having logged in on the device at some point in time. The user's login credentials are stored on the user's device in an encrypted form so that the user need not enter them each time the user visits the marketplace. Thus, a user may purchase items having logged in at some point in the past.

To improve the security of scenarios where a purchase may occur based on a login that occurred hours, days, months, or more ago, the marketplace may optionally pend the purchase until a condition is met. One such condition would be the expiration of a period of time that begins when the marketplace provides the consumer with a notification message of the purchase via one or more communication channels that the consumer has configured in his or her account settings. The time period provides the consumer with an opportunity to cancel an inadvertent or unauthorized transaction. For example, the marketplace may send a purchase notification message via one or more of the consumer's registered modes of communication (e.g., email, text, phone) and/or registered devices (e.g., primary device, secondary device). If more than one message is sent, the messages may be sent either simultaneously or sequentially. The contents of the message may indicate that the purchase will be processed at some time in the future, prompting the consumer to cancel the transaction, if necessary. Alternatively, the notification message may require the consumer to affirmatively confirm the purchase to move it out of the pended state in the marketplace. In this latter case, the failure to confirm the purchase would result in the purchase eventually being discarded or timing out.

### Consumer Experience

From the consumer's perspective, the marketplace 200 eliminates the role of the merchant as the gateway to products. Instead, consumers are presented with URIs that point to product pages that may or may not have branding identifying the source of the product. Consequently, some consumers may purchase products without having to know the identity of the merchant who may be fulfilling the order.

### Purchase Flow

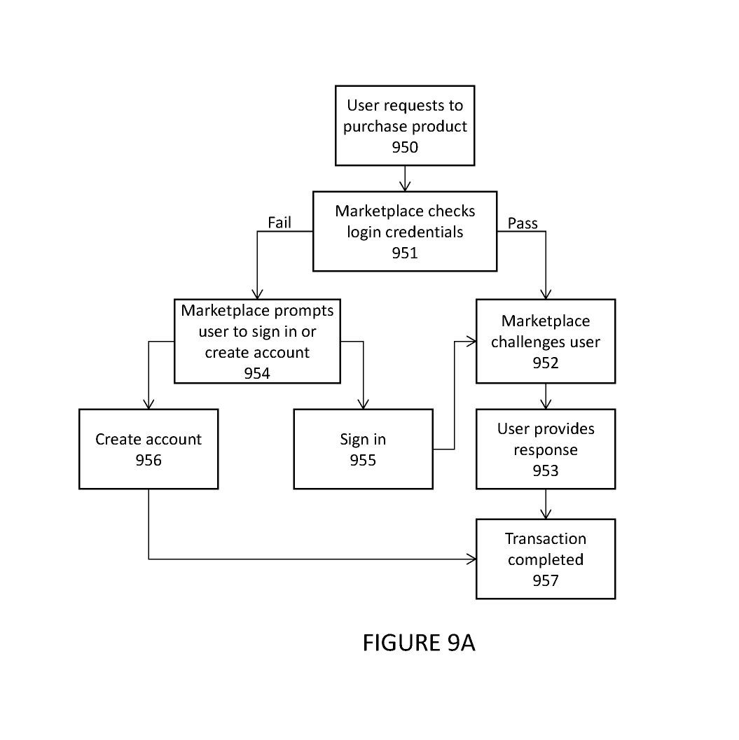

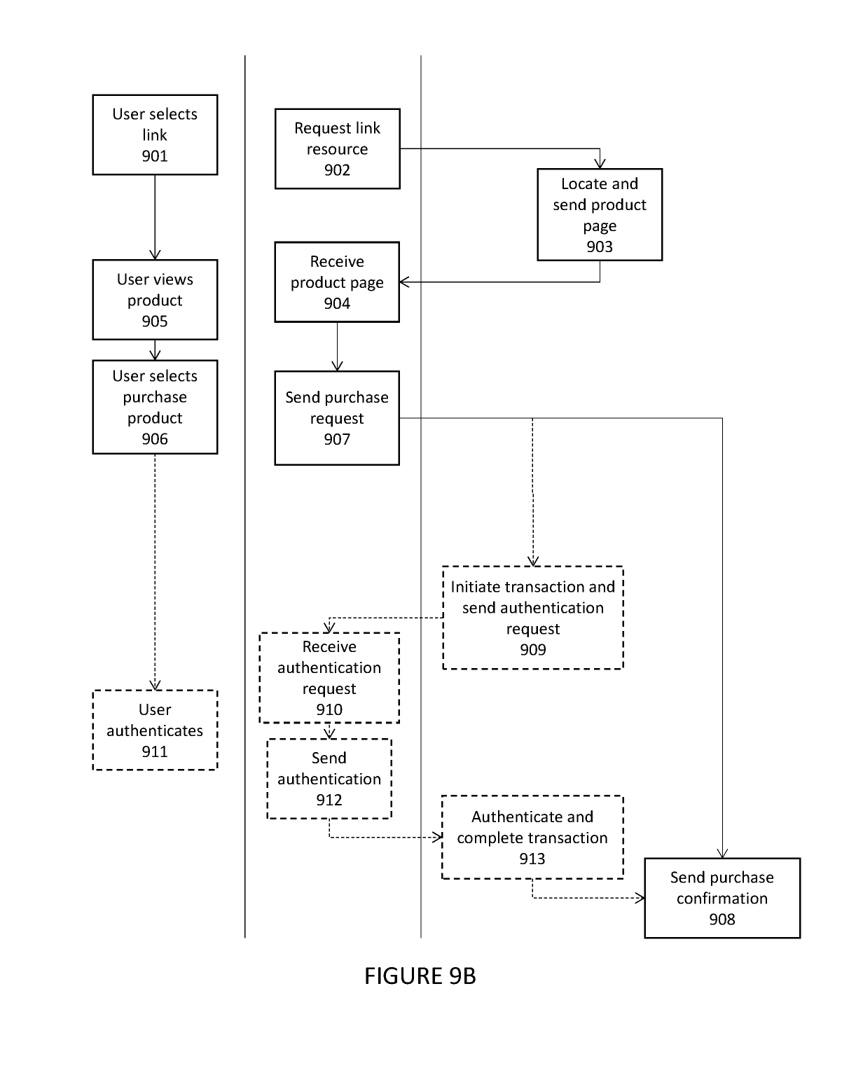

An exemplary purchase flow is depicted in FIG. 9A. At step 950, the consumer indicates that he or she wants to purchase a product. In response and at step 951, the marketplace checks whether the device from which the user has made the purchase request has previously logged into the marketplace. This may be performed by checking whether the device has stored data such as a cookie that indicates to the marketplace that consumer previously logged into the marketplace. The stored data may not expire, or may expire after a long period of time (e.g., one year) to limit the number of times the consumer must log into the marketplace. If the marketplace confirms that the user has previously logged in, the marketplace challenges the user to authenticate the purchase at step 952. This authentication step may be based on an encrypted or digitally signed message based on a randomly generated number, a previously stored PIN, or a biometric, as discussed elsewhere herein. The consumer responds to the challenge at step 953. If the response is correct, the marketplace completes the transaction at step 957.

If the marketplace determines that the consumer has not previously logged into the marketplace at step 951, the marketplace prompts the consumer to either sign in or to create an account at step 954. The consumer may sign in at step 955, after which the marketplace challenges the user as described above. If the consumer does not have an account, the consumer creates an account at step 956, which may include configuring their account details, including payment information and saving a response for future challenges.

Another exemplary purchase flow is depicted in FIG. 9B. The left column represents the number of steps that a consumer needs to perform in order to purchase a product. The middle column represents the steps carried out by the client device of the consumer. And the right column represents the steps carried out by the various services in the marketplace 200.

Notably, the consumer need not interact with a shopping cart to order a product or with a particular merchant site to compare products. In other words, the product page itself provides the option for the consumer to directly and without intermediate pages to complete a purchase, subject to any additional requirements imposed by an authentication scheme, if any. At step 901, a consumer may locate a link to a product during the normal course of the consumer's Internet usage (e.g., via a website or social media). At step 902, the consumer's device may request the resource located by the link in response to the consumer's selection either with a native web browser, third-party web browser, or a standalone application. The request may be a Uniform Resource Indicator. The request is routed the WS 214 at the marketplace 200 via the Internet.

Upon receiving the resource request, the WS 214 may service the request in a number of ways. Initially, the WS 214 determines the product to which the request corresponds. WS 214 does this by directly or indirectly consulting a data set that correlates links to product identification numbers. For example, WS 214 may request the product identification number from the PLS 210 by passing a parsed portion of the resource request to the PLS 210. The WS 214 may then retrieve product information from the product database 209 and generate an appropriate product page to transmit to the consumer's client that includes a product image and description. Alternatively, the WS 214 may look up the product via product database 209 based on a parsed portion of the resource request and retrieve the product information. Note that if the product has been removed by the merchant or if the product database indicates the merchant has zero inventory, the WS 214 may retrieve product information for the next most similar product and prepare a product page for that product with an indication that the requested product is unavailable. The next most similar product may be the product with the highest similarity score to the requested product, regardless of whether it is sold by the same merchant or a different merchant.

At step 904, the consumer's client receives the product page from the WS 214 and displays it on the consumer's device. At step 905, the consumer may review the information about the product displayed on the product page. Exemplary product pages are shown in FIGS. 10 and 12. As shown in FIG. 10, display area 1002 may include image(s) of the product, display area 1003 may include a description of the product, display area 1004 may include a link to purchase the product. The link or button may remain at a fixed location on the screen so that when a consumer scrolls through the product page, the button remains accessible. For example, the link may displayed in a frame that remains at the bottom of the product page, while the product information is displayed in a frame at the top of the product page which the consumer can scroll through to view the product information.

An optional display area 1001 may be included to allow the consumer to search the marketplace for other products. Link 1005 may be included and link to an identical or similar product sold from a different merchant, while link 1006 may be included and link to a similar product sold from the same merchant. Product page may optionally be configured to detect gestures such as a swipe left, right, up, or down, to navigate to different product pages in addition to or in the alternative of links 1005 and 1006.

At step 906, a consumer may select a link to purchase the product, for example link 1004 in FIG. 10. At step 907, in response to the selection, the consumer's device sends the purchase request. The purchase request may contain an indication of the product and a shipping address. The indication of the product may be the unique product identification number or an indication of the product page being displayed by the client. Depending on the authentication method in use, selecting the link may be sufficient to cause the order to be processed. In the case where no further authentication is required, upon receiving the purchase request, the marketplace sends a purchase confirmation to the consumer at step 908. The purchase confirmation may be another page prepared and transmitted via WS 214 and/or a text message or email prepared and transmitted by a notification service.

For security, additional authentication may be required to better ensure that the consumer associated with the account is the person making the purchase. The dashed components of FIG. 9B show these additional steps. Returning to step 907 after the consumer's device has sent a purchase request, the marketplace may initiate (but not complete) the transaction and send an authentication request to the consumer's device at step 909. At step 910, the consumer's device receives the authentication request and prompts the user to authenticate the purchase. Various forms of authentication may be used. In some embodiments, the marketplace may challenge the consumer to authenticate, to which the consumer may provide the response that the consumer previously saved with the marketplace, transmitted securely to the marketplace via TLS. In other embodiments, the consumer's device may encrypt or digitally sign a message using the consumer's device's unique private key and send the encrypted message and/or signature to the marketplace to authenticate the user. The message may be a random number generated by the marketplace (e.g., a PIN) and sent to the consumer via email, SMS, the Internet, or some other communications channel. The public key associated with the private key may have been transmitted and stored at the marketplace as part of a device registration, so the marketplace can authenticate the device.

The user may confirm their identity at step 911. In embodiments where the consumer has previously provided a challenge response to the marketplace, the consumer may provide the stored appropriate response to the marketplace. In other embodiments, such as where the marketplace sends a random number to the consumer, the encryption or signature of the number may optionally be permitted only upon confirming the biometric identity of the consumer (e.g., via fingerprint). At step 912, the response or message may be transmitted back to the marketplace. Note that the message transmitted back to the marketplace may be via email, SMS, the Internet, or some other communications channel.

In the case of a message transmitted via a separate communications channel, the message itself may alert the consumer to fraudulent activity. Consequently, to expedite interruption of a potentially fraudulent activity, the consumer may send a respond to the marketplace (e.g., with a keyword “FRAUD”). Upon receipt of such a message, the marketplace immediately terminates the transaction and gathers and logs information related to the session established with the potential imposter's client device. The consumer may also ignore the text message and the marketplace would delete the pended purchase record after a certain period of time (e.g., 10 minutes, 1 hour, etc.).

At step 913, the marketplace receives the authentication (e.g., encrypted message) and thus infers the identity of the device or the consumer if the digital signature is confirmed or message is decrypted. The marketplace then continues to process the transaction that was initiated at step 909 and sends a purchase confirmation at step 908.

The interface depicted in FIG. 11 also shows an option for permitting a consumer to authenticate while simultaneously selecting the shipping address for the purchased product. If the message to be used for authentication is sent to the consumer via email or SMS, the consumer may enter the message in field 1101. Additionally, if the consumer has configured his or her account with multiple shipping addresses, multiple links (e.g., 1102a-1102c) may appear to select a shipping address and confirm the purchase. FIG. 11 may appear when the consumer's device prompts the consumer for authentication at step 910.

FIG. 12 depicts an alternative product page. Display area 1201 may include image(s) of the product, display area 1202 may include a description of the product, and display area 1204 may include a link to purchase the product. Display area 1203 may provide a drop-down menu through which the consumer may selecting the shipping address for the product prior to selecting the link in display area 1204 to purchase the product.

Note that the flow depicted in FIG. 9B does not depict how the WS 214 identifies the consumer. One technique the WS 214 may use is to request information stored in a cookie on the consumer's device, assuming the consumer has already logged into the marketplace at some point in the past and the consumer's device has a stored account credentials (e.g., a cookie as described in FIG. 9A).

Given the ease with which a consumer may make a purchase, completed transactions may be held (a second time, if authentication was required) for a certain period of time after the purchase is confirmed to permit the consumer to cancel the transaction.

### Product Discovery and Price Comparison

Recall that the PRS 207 may relate products both across merchants and from the same merchant. In doing so, the consumer may easily identify similar and/or identical products, enabling the consumer to locate other competing products that meet the consumer's need and/or price compare. Returning to FIG. 10, links 1005 and 1006 may provide the consumer with the ability to navigate between such products. Alternatively, various touch screen gestures (e.g., swipe left or right) may be used to request product pages.

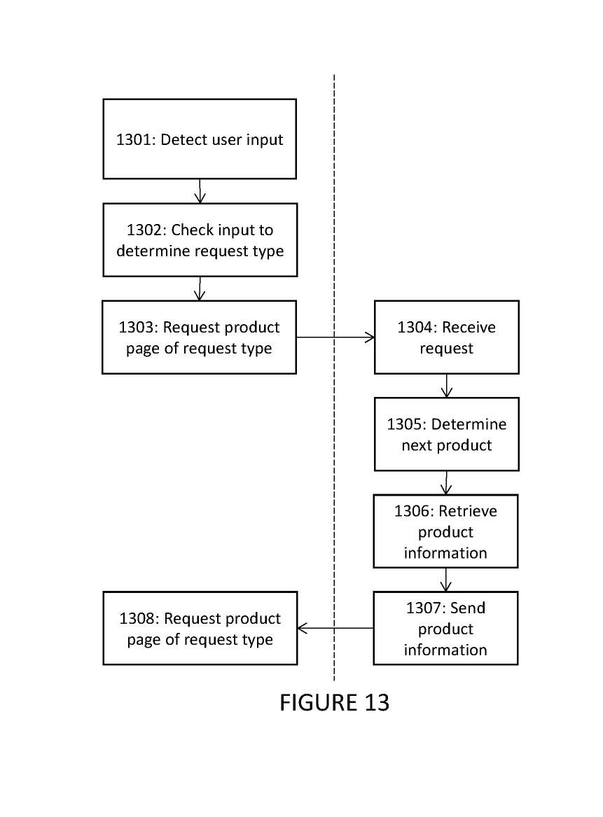

FIG. 13 depicts an exemplary process through which a consumer may request and the marketplace may provide product pages for similar and/or identical products. The process begins when the consumer is viewing a product page. Beginning at step 1301, the consumer's device detects an input. At step 1302, the consumer's device checks the input to determine the request type, if any. For example, the consumer's device may respond to a touch input at the screen location of link 1005 or 1006. Alternatively, if the input is a gesture and the product page is configured to respond to gestures, the consumer's device checks whether the gesture was, for example, a swipe left or a swipe right. At step 1303, if the input corresponds with an input that requests the next most similar product from the same merchant or the next most similar (or identical product) from a different merchant, the consumer's device sends information indicating the type of request and a request for that product page to the marketplace (e.g., WS 214). That request may include an identity of the current product being viewed. At step 1304, the WS 214 receives the product page request, and, at step 1305, determines whether the product page request is for a product page from the same or from a different merchant. The WS 214 directly or indirectly obtains the identity of the next product by consulting a service or database that contains the results of analysis performed by the PRS 207, described above. For example, the WS 214 may consult the entry in the product database 209 that stores the similar products for the product page being viewed by the viewer to determine the product identification number for the next most similar product (either at the same merchant or a different merchant). At step 1306, the WS 214 may obtain the product information for the identified product, including for example an image and a description of the product. At step 1307, the WS 214 responds to the consumer device's request with the product information for display on the next product page to be viewed by the consumer, and at step 1308, the consumer's device displays the requested product page.

Note that when the WS 214 provides the original product page to the consumer's device, it may also send information related to an integer number of similar products both from the same merchant and from different merchants. For example, the WS 214 may provide the originally requested product page to be displayed, along with the information necessary to display the five next most similar products form the same merchant and the five next most similar products from a different merchant. These product pages are “pre-fetched” to reduce the latency the consumer experiences when they navigate to “adjacent” product pages. These pre-fetched product pages may be stored in a buffer in the consumer's device. When the consumer navigates to one of the pre-fetched product pages, the consumer's device requests the product information for the next most similar product that has yet to be requested to keep the buffer filled with whatever number of product pages are being pre-fetched.

Note that a consumer may identify a product that he or she likes and wants to share. When the marketplace responds to requests for similar and/or identical products, the response includes the link to the primary link associated with the similar/identical product to be displayed to the consumer. For example, if a user originally requested the product page located at http://a.com/handcrafted_chair_sale and navigated to a related product, the product page for the related product would display the primary link (either in the address bar of the browser or in another field on the product page) for the related product (e.g., http://a.com/handcrafted_wicker_chair_sale). The consumer could then copy the primary link and share it with his or her network.

### Implementation

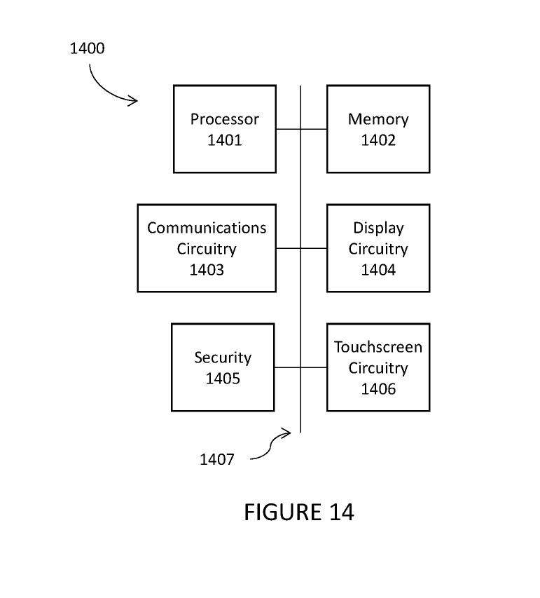

FIG. 14 depicts an exemplary electronic device which may be used by a consumer or merchant. Processor 1401 controls the general operation of the device. Memory 1402 may include volatile and nonvolatile memory, including instructions for carrying out the operations described herein as being performed by the user device. Processor 1401 may send and receive data via communications circuitry 1403. Communications circuitry 1403 may include wired and/wireless communications circuitry, including one or more transmitters and one or more receivers. Processor 1401 may display information to the consumer via display circuitry 1404, which may include a liquid crystal display and/or one or more light emitting diodes. Consumer may command the device via touchscreen circuitry 1406. Touchscreen circuitry may be capacitive or resistive, and overlay the physical display are of display circuitry 1404. Other input devices may be used, such as a keypad (whether physical or digital), stylus, mouse, or microphone. Security circuitry may include security features described herein, such as a secure environment for storing a device's private key and circuitry for reading a user's fingerprint. Communications between the components shown in FIG. 14 may be carried over a bus or other interconnect 1407. Each component may read information from another component or write information from another component.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following.

1. A computer-implemented method of providing a product marketplace, comprising executing on one or more processors the steps of:
receiving product information from a first device, the product information comprising an image and a description;
in response to receiving the product information, creating a product record in a first database, the product record having a unique product identification number, the product record storing the image and the product description or having a reference to the image and a reference to the product description;
generating a reference to the product record;
receiving the reference to the product record from a second device as part of a product page request;
retrieving at least a portion of the product record from the first database;
generating the product page, the product page comprising the portion of the product record retrieved from the first database; and
sending the product page to the second device.

2. The computer-implemented method of claim 1, further comprising:
updating a merchant record in a second database with a reference to the product record or the unique product identification number.

3. The computer-implemented method of claim 1, wherein the first database and the second database are the same database.

4. The computer-implemented method of claim 1, further comprising:
generating a plurality of similarity scores, each similarity score measuring the similarity between the product record and each of a plurality of other product records; and
relating the product record with a plurality of other product records based on the generated similarity scores.

5. The computer-implemented method of claim 4, wherein the product record is associated with a first merchant and further comprising:
receiving a request for a second product page that includes an indication of whether the second product page relates to a product associated with the first merchant or with a second merchant that is different from the first merchant; and
determining the identity of the second product based on one of the plurality of similarity scores and the indication;
retrieving at least a portion of a second product record from the first database based on the identity of the second product;
generating the second product page, the second product page comprising the portion of the second product record retrieved from the first database; and
sending the second product page to the second device.

6. The computer-implemented method of claim 1, further comprising:
receiving, after sending the product page to the second device and without sending any other pages to the second device, a purchase request that includes an indication identifying the product; and
initiating a purchase transaction in response to receiving the purchase request.

7. The computer-implemented method of claim 6, further comprising:
sending an authentication request to the second device, the authentication request prompting a consumer to perform an action;
receiving an authentication response based in part on the consumer's performance of the action; and
completing the purchase transaction.

8. The computer-implemented method of claim 7, wherein the authentication response is an encrypted or digitally signed PIN.

9. The computer-implemented method of claim 4, wherein the product record is associated with a first merchant and wherein the relating the product record comprises:
storing, in sorted order, a unique product identification number for each of the plurality of other product records whose similarity scores to the product record exceeds a threshold and is associated with the first merchant;
storing, in sorted order, a unique product identification number for each of the plurality of other product records whose similarity scores to the product record exceed a threshold and is not associated with the first merchant.

10. The computer-implemented method of claim 1, further comprising:
generating a second reference to the product record, the second reference being different than the reference;
receiving the second reference to the product record from a second device as part of a product page request;
retrieving at least a portion of the product record from the first database;
generating the product page, the product page comprising the portion of the product record retrieved from the first database; and
sending the product page to the second device.

11. A computer-implemented method of purchasing a product, comprising executing on one or more processors the steps of:
sending a request based on a URI;
receiving a product page related to a first product available from a first merchant in response to the request;
displaying the product page;
receiving an input from a user;
determining whether the input was of a first type; and
if the input was of a first type, sending a purchase request based in part on information contained in the product page and without placing the first product in a shopping cart.

12. The computer-implemented method of claim 11, further comprising:
determining whether the input was of a second type; and
if the input was of a second type, sending a request for a product page containing information related to a second product, wherein the second product either (a) is similar or identical to the first product and available from a second merchant that is different from the first merchant or (b) is similar to the first product and available from the first merchant.

13. The computer-implemented method of claim 12, wherein the input of the first type is a touch on a location on a display coupled to the one or more processors and the input of the second type is a gesture on the display.

14. The computer-implemented method of claim 11, wherein the URI provides a human-readable indication of one or more of a type of the first product, a discount on a price of the first product, and an identity of the first merchant.

15. The computer-implemented method of claim 11, wherein displaying the product page comprises displaying an image of the first product, a description of the first product, and a link to purchase the first product.

16. The computer-implemented method of claim 11, further comprising:
receiving an authentication request page that includes a field for entry of a code;
sending an authentication response in response to entry of the code.

17. The computer-implemented method of claim 16, further comprising:
receiving the code via SMS or email.

18. The computer-implemented method of claim 11, further comprising:
receiving an authentication request page that includes a prompt for a biometric input;
sending an authentication response in response to receipt of the biometric input.

19. The computer-implemented method of claim 12, further comprising:
receiving a product page related to the second product; and
displaying the product page related to the second product.

20. The computer-implemented method of claim 19, further comprising:
wherein the displaying of the product page related to the second product includes displaying a primary link associated with the second product.
